(19) United States
(12) Patent Application Publication
(10) Pub. No.: US 2006/0009081 A1
(43) Pub. Date: Jan. 12, 2006

(54) Safety electrical connection assembly for appliances

(76) Inventor: James Taylor Lloyd, New York, NY (US)

Correspondence Address: STEVEN A. GARNER;CONAIR CORPORATION, ONE CUMMINGS POINT ROAD, STAMFORD, CT, 06902, US

(21) Appl. No.: 11/178,829

(22) Filed: Jul. 11, 2005

Related U.S. Application Data
(60) Provisional application No. 60/586,962, filed on Jul. 9, 2004.

(51) Int. Cl. H01R 24/00

(52) U.S. Cl. 439/660

(57) ABSTRACT

An electrical connection assembly enables selective contact between terminal ends and appliance conductors while preventing inadvertent contact with terminal ends when not in use, wherein the need for complex or moveable parts is eliminated. Terminal ends are sunk into openings in a base such that they cannot be contacted by any person or object larger than the openings into which they are sunk. A spring leaf is arranged to form each terminal. The appliance conductor pins are shaped and sized to enter the openings into which the terminal ends are sunk, and to simultaneously block access to the openings by any other objects. The pins enter into and are held against the leaf springs.

### CROSS-REFERENCE TO RELATED APPLICATIONS

This application claims priority to U.S. Provisional Patent Application Ser. No. 60/586,962 filed on Jul. 9, 2004, incorporated herein by reference in its entirety.

### BACKGROUND OF THE INVENTION

1. Field of the Invention

The present invention relates to electrical connection assemblies and, more particularly, to electrical connection assemblies that enable selective contact between terminal ends and appliance conductors while preventing inadvertent contact with terminal ends when not in use.

2. Description of Related Art

Various electrical appliances exist in which it is desirable to allow one or more parts to be removed from a base, in which the base conducts electrical energy from an external power source and transfers the energy to the removable part. For example, certain cooking appliances have an electrical base with a removable pot or griddle, wherein the pot or griddle has conductive pins that, when in conductive contact with the base, provide electrical energy to on-board heat elements.

Known devices achieve this result by providing a movable cover on the base, whereby the cover selectively slides over the terminal ends on the base to protect them while the removable part is disengaged. When the removable part is engaged, one or more mechanisms cause the cover to be slid away from the terminal ends to expose them and allow them to contact the appliance conductor pins.

### OBJECT AND SUMMARY OF THE INVENTION

It is an object of the present invention to overcome the shortcomings of the prior art mentioned above. These and other objects are achieved by the present invention described herein.

It is desirable to provide an electrical connection assembly that enables selective contact between terminal ends and appliance conductors while preventing inadvertent contact with terminal ends when not in use, wherein the need for complex or moveable parts is eliminated. The elimination of such parts eliminates potential wear, costs, and complexity in assembly. Furthermore, safety is enhanced because potential of failure is eliminated.

The present invention achieves these and other objectives by provided terminal ends that are sunk into openings in a base such that they cannot be contacted by any person or object larger than the openings into which they are sunk. In order to provide positive contact and resistance to pull-out, a novel spring leaf design is employed. The appliance conductor pins are shaped and sized to enter the openings into which the terminal ends are sunk, and to simultaneously block access to the openings by any other objects. The pins enter into and are held by the leaf spring, which pushes the pin and a pin support against the interior wall of the opening.

### BRIEF DESCRIPTION OF THE DRAWINGS

The present invention is more fully understood by reference to the following detailed description of an illustrative embodiment with the drawings identified below.

FIG. 1 is a side, sectional view of the connector assembly according to the present invention in a “disassembled” state.

FIG. 2 is a side, sectional view of the connector assembly according to the present invention in an “assembled” state.

### DETAILED DESCRIPTION OF THE INVENTION

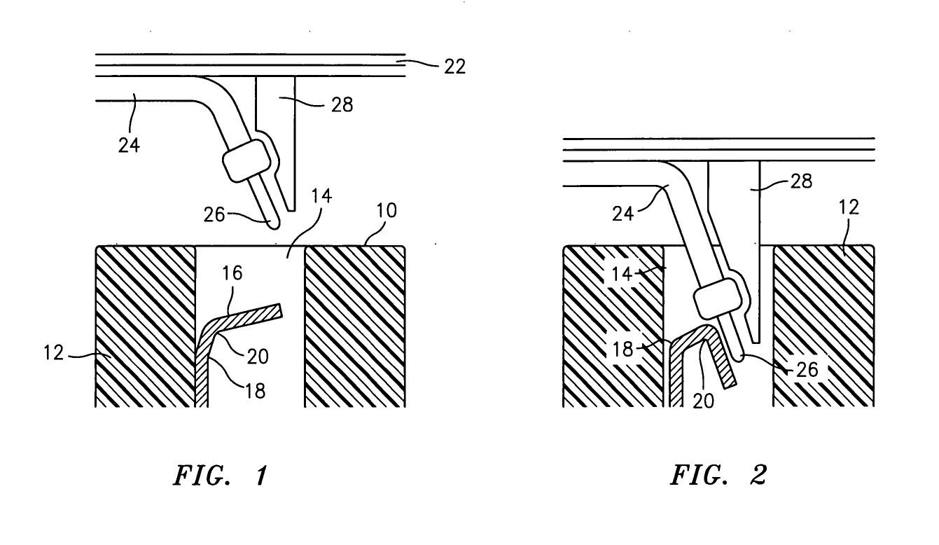

Referring to FIGS. 1 and 2, the top surface 10 of an electrical appliance base 12 has a plurality of openings such as opening 14. This opening 14 contains an electrical terminal in the form of a spring 16. The spring has two flexible bends 18, 20 which flex between the positions shown in FIGS. 1 and 2, as described below. A removable appliance part 22 has a plurality of conductor pins like the conductor pin 24, which has a tip 26. A pin support 28 is also provided to brace the pin 24 when engaged with the terminal spring 16 as shown in FIG. 2. The conductor pins 24 can be of various types, such as calrod pins.

FIG. 1 shows the electrical connection assembly in its “disassembled” state. FIG. 2 illustrates the assembly in its “assembled” state. When the removable appliance portion 22 is operatively joined to the electrical base 12, as shown in FIG. 2, the conductor pin 24, 26 enters the opening 14 so that the pin tip 26 contacts the spring 16. The spring 16 flexes at the joints 18, 20 but is biased against the pin tip 26 to maintain electrical contact. The pin support 28 keeps the pin tip 26 relatively positioned in the opening 14. When the removable appliance portion 22 is removed from the electrical base 12, the spring 16 reverts to its initial shape, as shown in FIG. 1. The present invention also contemplates the use of a various number of joints in the spring 16, so that the spring 16 can flex in various ways.

The spring 16 is sunk within the opening 14, preferably at a distance from the edge of the opening 14 to prevent inadvertent contact with the spring 16. In a preferred embodiment, the diameter of the opening 14 is small enough to prevent an operator's fingers from entering the opening 14. In another embodiment, the conductor pin 24 and the pin support 28 substantially block any foreign objects from entering the opening 14.

The base 10 is connected to an external electric source to provide power to the base for supplying power to the removable appliance portion 22. The removable portion 22 may have an element such as a heater that is driven by the power.

The present invention assembly is suitable for use with a variety of appliances including, but not limited to, fryers, fry pans, kettles and griddles for consumer use.

While a preferred embodiment of the invention has been herein disclosed and described, it is understood that various modifications can be made without departing from the scope of the invention.

What is claimed is:

1. An electrical connection assembly for an appliance comprising:
a first portion selectively removable from said appliance;
a second portion protruding from a base of said appliance, said second portion having an opening;
a live electrical terminal within said opening, wherein said live electrical terminal is a spring biased contact; and
a conductor pin on said first portion adapted to be received within said opening to contact said live electrical terminal.

2. An electrical connection assembly according to claim 1, further comprising
a pin support on said first portion to brace said conductor pin when engaged with said live electrical terminal.

3. An electrical connection assembly according to claim 1, wherein
said live electrical terminal has a first flexible joint and a second flexible joint to enable said spring biased contact to bend when in contact with said conductor pin.

4. An electrical connection assembly according to claim 1, wherein
said live electrical terminal is biased to flex against and maintain contact with said conductor pin.

5. An electrical connection assembly according to claim 1, wherein
said live electrical terminal is sunk in said opening.

6. An electrical connection assembly according to claim 1, wherein
said live electrical terminal is distanced from the edge of the opening of said opening to prevent inadvertent contact with said live electrical terminal.

7. An electrical connection assembly according to claim 1, wherein
said opening has a diameter small enough to prevent an operator's fingers from contacting said live electrical terminal.

8. An electrical connection assembly according to claim 1, wherein
said conductor pin and said pin support substantially block foreign objects from entering said opening.
